(19) United States
(12) Patent Application Publication
(10) Pub. No.: US 2002/0023001 A1
(43) Pub. Date: Feb. 21, 2002

(54) Method and apparatus for online creation and sale of custom local store marketing materials

(76) Inventors: James A. McFarlin, Marina Del Rey, CA (US); Margaret T. McFarlin, Marina Del Rey, CA (US)

Correspondence Address: CHRISTIE, PARKER & HALE, LLP, P.O. BOX 7068, PASADENA, CA, 91109-7068, US

(21) Appl. No.: 09/904,184

(22) Filed: Jul. 11, 2001

Related U.S. Application Data
(60) Provisional application No. 60/217,491, filed on Jul. 11, 2000.

(51) Int. Cl. G06F 17/60

(52) U.S. Cl. 705/14

(57) ABSTRACT

A method and apparatus for producing marketing materials for a retail establishment. A corporate sponsor generates marketing material information for use by franchisees in marketing products and services supplied by the corporate sponsor. The marketing material information is stored on a Web server accessible by the franchisees. The franchisees use the marketing material information to generate proposed marketing material designs. The proposed marketing material designs are submitted electronically to the corporate sponsor for approval. If approved, the marketing material designs are electronically transmitted to a printer where the actual marketing materials are produced and shipped to the franchisee.

### CROSS-REFERENCE TO RELATED APPLICATION

The present application claims priority to U.S. Provisional Patent Application No. 60/217,491, filed Jul. 11, 2000, which is hereby incorporated by reference as if set forth in full herein.

### TECHNICAL FIELD OF THE INVENTION

This invention relates generally to the generation of printed materials and more specifically to printing customized local store marketing materials.

### BACKGROUND OF THE INVENTION

Retail bricks-and-mortar businesses (retail establishments) survive and prosper, in large measure, based on revenues generated from in-store sales. Each retail establishment seeks to attract customers from the local trade area and finds itself in competition with those businesses which may be located nearby offering similar products and services.

The battle for retail customers is generally based on factors such as convenient location, customer service, price, brand recognition, national and local store marketing. Retail establishments have historically sought solutions to effectively and economically market directly to potential customers located in the immediate neighborhood and surrounding community.

Presently, a variety of traditional methods are currently in practice to accomplish the goal of local store marketing, including advertising in publications such as telephone directories, or in a host of local retail trade publications that are either direct delivered or mailed to households.

Retail establishments also distribute printed marketing materials, either by mail or directly, in the local trade area and post printed advertisements and notices at the retail site in order to attract and retain customers.

Retail establishments typically acquire these marketing materials through a number of means. Marketing materials may be developed at the local level, through the use of personal computers and off-the-shelf software. The advantages are convenience and low costs. However, issues such as design, print quality and output choices are real constraints. E.g., graphic elements available for use may be limited or of lesser quality. In addition, items such as building signs, door hangers and frequent-buyer cards can not be produced on a desk-top printer for various reasons, including oversized dimensions, special paper stock or ink requirements and special post-printing process requirements such as die-cutting.

Retail establishments may also work with printers to develop marketing materials. Printing-related issues are no longer constraints. However, a small, print job such as this is relatively expensive to produce, and it may be time-consuming to coordinate and schedule press time.

Retail establishments may also contract with advertising or design agencies to create marketing materials. Design is done by professionals and printing can be handled through printers with business relationships with the agencies. However, the costs involved likely will be prohibitive for a single, independent retail establishment.

Retail establishments whose business is a franchise may also have access to pre-approved printed marketing materials developed by a franchiser that can be used in local store promotions. However, the content of the marketing materials will not be customized for the retail establishment. Furthermore, if the retail establishment operates different profit centers under different franchises, there are no readily available marketing materials, developed by any of the franchisors or product manufacturers, that allow the retail establishment to conduct cross-promotions simultaneously featuring products offered by multiple franchisors or product manufacturers. For example, a retail establishment may operate a branded petroleum retail location with a branded quick-service restaurant and therefore the retail establishment has a gasoline franchise and a fast-food franchise. Any marketing materials provided by either of the franchisors will be only for its own franchise.

Moreover, for retail establishments whose business is a franchise, invariably, the franchisor requires all printed marketing materials bearing any trademarked or proprietary elements be approved in writing by the franchiser prior to use. It is often a time-consuming process and requires much manual work on the part of the retail establishment to secure the written approval. The difficulty is compounded when multiple franchises are involved.

Currently, there exists no system or method for a retail establishment to go online and create custom marketing materials in an interactive environment, quickly, conveniently, professionally and economically, and secure all necessary approvals by franchisors electronically.

### SUMMARY OF THE INVENTION

In one aspect of the invention, a computer implemented method is provided for producing marketing materials for a retail establishment. The method includes receiving marketing material information from a corporate sponsor which is used to generate a marketing material completed design. The marketing material completed design is transmitted to the corporate sponsor for approval. The marketing material completed design is transmitted to a printer for production of the marketing materials upon receiving corporate sponsor approval.

According to another aspect of the invention, the corporate sponsor marketing material further includes pre-approved promotional calendars, special product offers, design templates, product images, graphic elements, and logos.

According to another aspect of the invention, the marketing material information is presented to the retail establishment and the retail establishment selects the marketing material information to be used to generate the marketing material completed design.

According to another aspect of the invention, a marketing material design template is transmitted to the retail establishment. The marketing material design template assists the retail establishment in selecting marketing material information used to generate a marketing material completed design.

According to another aspect of the invention, the retail establishment generates a marketing material proposed design. The marketing material proposed design is transmitted to a graphics designer and the graphics designer generates a marketing material completed design from the marketing material proposed design.

According to another aspect of the invention, a low-resolution marketing material completed design is generated from the marketing material completed design and transmitted to the retail establishment for approval purposes.

According to another aspect of the invention, the marketing material information includes marketing material information from a franchisor. The combined corporate sponsor and franchiser marketing material information is used to generate the marketing material completed design.

According to another aspect of the invention, historical demand, in-progress orders pending approval, and forecast demand are analyzed to determine press-run needs and press time is reserved with the printer to meet the press-run needs.

According to another aspect of the invention, a plurality of marketing material completed designs are accumulated. A combined press run is generated from the plurality of marketing material completed designs and the combined press run is transmitted to a printer for production of the marketing materials.

### BRIEF DESCRIPTION OF THE DRAWINGS

These and other features, aspects, and advantages of the present invention will become better understood with regard to the following description and accompanying drawings wherein:

FIG. 1 is a block diagram illustrating one embodiment of the present invention;

FIG. 2 depicts a block diagram of an exemplary design management system (DMS);

FIG. 3 depicts a block diagram of an exemplary interactive design creation system (IDCS);

FIG. 4 depicts a block diagram of an exemplary project management system (PMS);

FIG. 5 depicts a block diagram of an exemplary print production allocation system (PPAS);

FIG. 6 illustrates an exemplary product image database;

FIG. 7 illustrates an exemplary cross-promotion database;

FIG. 8 illustrates an exemplary sponsor requirements database;

FIGS. 9a-9c illustrate an exemplary order tracking database;

FIG. 10 illustrates an exemplary print reservation database;

FIG. 11 illustrates an exemplary print combo-run allocation database;

FIG. 12 illustrates an exemplary print combo-run setup vs. a single-order setup;

FIG. 13a and FIG. 13b are flowcharts illustrating an exemplary process by which a retail establishment creates custom marketing materials and places a conditional order online;

FIG. 14a and FIG. 14b are flowcharts illustrating an exemplary process by which the design for a conditional order is completed and all necessary approvals are secured to release the order from hold;

FIG. 15 is a flowchart illustrating an exemplary process by which press time is reserved to meet forecast demand;

FIG. 16 is a flowchart illustrating an exemplary process by which orders are combined to reduce print production costs;

FIG. 17 is a diagram depicting an exemplary deployment of an embodiment of a webLSM server and exemplary client hosts accessing the embodiment of a webLSM via a computer network;

FIG. 18 is a diagram depicting an embodiment of an approval process according to the present invention; and

FIG. 19 is a hardware architecture diagram of an embodiment of a general purpose computer suitable for use as a webLSM host.

### DETAILED DESCRIPTION OF THE INVENTION

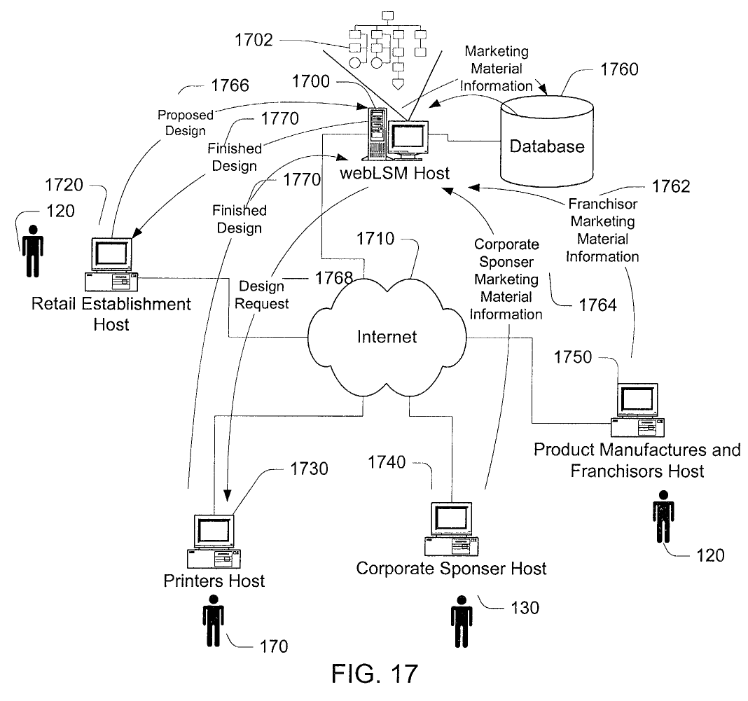

FIG. 17 is a diagram depicting an exemplary deployment of an embodiment of a Web-based Local Store Marketing (webLSM) server and exemplary client hosts accessing the embodiment of a webLSM via a computer network. A webLSM server 1702 is hosted by a webLSM host 1700 operably coupled to a computer network such as the Internet 1710. The webLSM server is a data processing system coordinating the operations of a retail establishment 110, a printer 170, a corporate sponsor 130, and a franchiser or product manufacturer 120 (a franchiser or a product manufacturer other than the webLSM corporate sponsor is herein termed a franchisor) in order to produce printed marketing materials for use in a retail establishment.

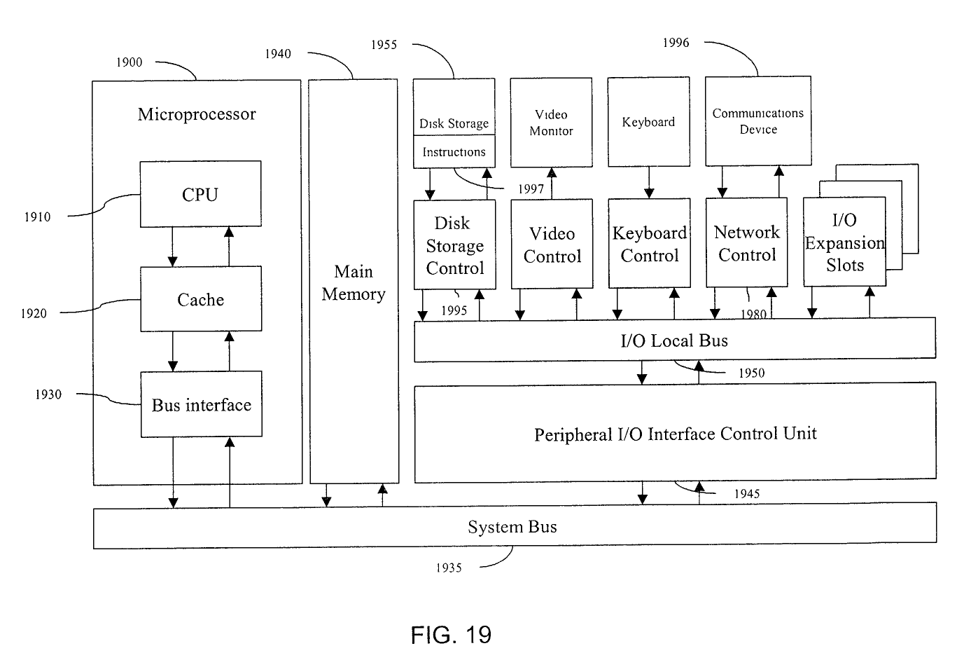

FIG. 19 is a hardware architecture diagram of an embodiment of a general purpose computer suitable for use as a webLSM host. A microprocessor 1900, comprising a Central Processing Unit (CPU) 1910, a memory cache 1920, and a bus interface 1930, is operatively coupled via a system bus 1935 to a main memory 1940 and a I/O control unit 1945. The I/O control unit is operatively coupled via a I/O local bus 1950 to a disk storage controller 1995, and a network controller 1980.

The disk storage controller is operatively coupled to a disk storage device 1925. Computer program instructions 1997 for implementing a webLSM server are stored on the disk storage device until the microprocessor retrieves the computer program instructions and stores them in the main memory. The microprocessor then executes the computer program instructions stored in the main memory to implement the features of a webLSM server.

The network controller is operatively coupled to communications device 1996. The communications device is adapted to allow a webLSM server hosted by the general purpose computer to communicate via a computer network such as the Internet with other software objects on the computer network.

Referring now to FIG. 17, the webLSM host 1700 is operably coupled to a retail establishment host 1720, a printer host 1730, a corporate sponsor host 130, and a franchiser host 1750 via the Internet 1710. The retail establishment uses a Web browser (not shown) hosted by the retail establishment host to access the webLSM server. A printer uses a Web browser (not shown) hosted by the printer host to access the webLSM server via the Internet. The corporate sponsor uses a Web browser (not shown) to access the webLSM server via the Internet. The franchiser use a Web browser (not shown) to access the webLSM server via the Internet.

In operation, a corporate sponsor transmits corporate sponsor marketing material information 1764 to the webLSM server. The corporate sponsor marketing material information include graphics and marketing relationship standards that should be adhered to by a retail establishment when using products supplied by a corporate sponsor. The webLSM receives the corporate marketing material information and stores them in a database 1760 for future use. A franchisor transmits franchiser marketing material information 1762 to the webLSM server using a Web browser. The franchisor marketing material information include graphic and marketing relationship standards that should be adhered to by a retail establishment that is a franchisee of the franchisor. The webLSM receives the franchisor marketing material information and stores them in the database for future use. In one embodiment of a webLSM server according to the present invention, the marketing material information include current marketing material design templates, product images, graphic elements, promotional calendars and special promotional product offers.

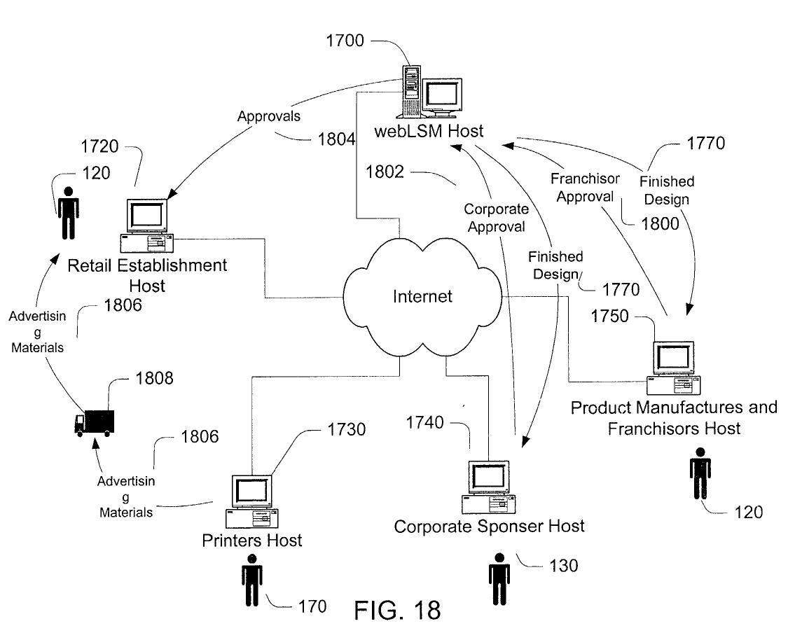

A retail establishment uses a Web browser (not shown) hosted by the retail establishment host to access the webLSM server. The retail establishment creates a proposed design 1766 for marketing material to be used by the retail establishment using services supplied by the webLSM. The webLSM supplies art work from the database in order to help the retail establishment in developing the marketing materials. The proposed design is transmitted from the retail establishment to the webLSM server and stored by the webLSM server. The proposed design is then transmitted by the webLSM server to the printer's host. The printer's host receives the proposed design and the printer generates a completed design 1770 from the proposed design. For example, the proposed design created by the retail establishment may not contain all of the necessary detail required for a printer to properly set up a print job. Experts employed by the printer use the proposed design to generate a completed design with all of the necessary details included. The completed design is transmitted back to the webLSM server by the printer host and the webLSM server stores the completed design until the retail establishment requests the completed design 1770 for viewing. The completed design may or may not be subject to an approval process as depicted in FIG. 18.

FIG. 18 is a diagram depicting an embodiment of an approval process according to the present invention. The completed design is transmitted by the webLSM server to the corporate sponsor. The corporate sponsor receives the completed design and reviews the completed design and generates a corporate approval 1802 that is transmitted to the webLSM server. The completed design is also reviewed by the franchiser and the franchiser generates a franchiser approval that is transmitted to the webLSM server. The webLSM receives the approvals and transmits an approval 1804 notification to the retail establishment. The webLSM server also transmits the approvals to the printer who then generates marketing material 1806 by printing the marketing material according to the approved completed design. The printer then ships the marketing material to the retail establishment using a common carrier 1808. The retail establishment receives the marketing material and uses the marketing material to promote the business of the retail establishment.

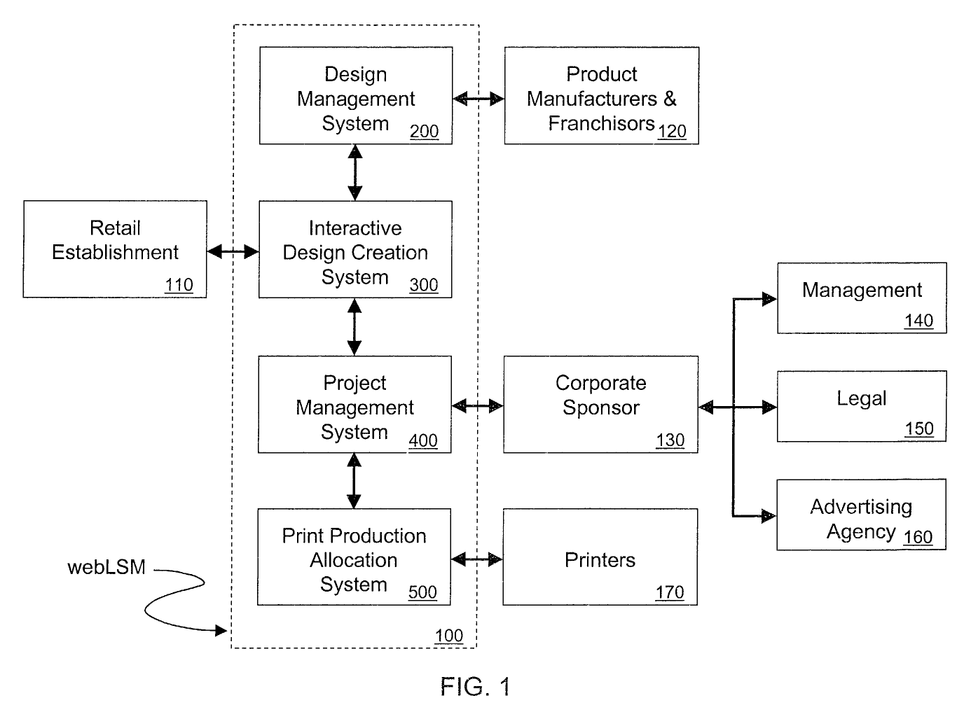

In somewhat further detail, FIG. 1 illustrates an embodiment of a webLSM according to the present invention. As shown in FIG. 1, a retail establishment 110 accesses the Interactive Design Management System (IDMS) 200 included as an component of the webLSM server 100 via the Internet to create custom local store marketing materials and place an order for print production.

The webLSM server 100 establishes and maintains business alliance with a corporate sponsor 130 and makes access via online communication available to retail establishments 110 that are affiliated with the corporate sponsor, typically through a franchise relationship. The webLSM server is an online system which the corporate sponsor offers to retail establishments, its franchisees, as a service allowing retail establishments to create professional-quality custom marketing materials. Additionally, with a well-established communication channel through the webLSM, a corporate sponsor controls quality and brand consistency issues involved in local store marketing materials.

The use of a webLSM server also establishes and maintains relationships with franchisors 120 to automate and facilitate the local store marketing material creation and approval processes. Retail establishments may operate different profit centers under different franchises and therefore have franchise relationships with franchisors other than the corporate sponsor 130. Franchisors typically plan national and regional promotions well in advance and produce promotional calendars to communicate with their customers and franchisees. Special pricing on promotional products may be offered within specific time periods. Most manufacturers and franchisors require that promotional materials created by retail establishments be submitted for their approval to ensure proper and consistent treatment of their trademarks and logos. The webLSM server 100 functions as an online depository, capturing marketing material information on promotional calendars, special offers, and pre-approved graphic elements. Retail establishment 110 may browse through the promotional calendars to determine when to schedule the local promotion and what theme may be a good fit. Retail establishment may also review the special offers to determine whether there are cross-promotion opportunities.

Franchisors access the DMS 200 to supply and keep current marketing material design templates, product images, graphic elements, promotional calendars and special promotional product offers. Allowing retail establishments to create custom local store marketing materials using graphic elements including trademarks and logos supplied by franchisors greatly enhances the probability that the final design will be approved. Franchisors may also use the webLSM server to drive sales of a specific product by making a special product offer and getting that information to retail establishments via the webLSM server.

The retail establishment reviews promotional calendars, current promotions and special product offers to determine which of the current promotions and special product offers the retail establishment will use for local store promotion and featured products. The retail establishment then specifies what types of marketing materials and quantities of each type are desired. Marketing materials include building signs, flyers, coupons, door hangers, bag stuffers, frequent-buyer cards, etc. All marketing materials may be customized based on the same design specifications; the retail establishment does not need to repeat the creation process to complete the design for each type of marketing material.

An Interactive Design Creation System (IDCS) 300 includes a plurality of pre-designed templates with different and distinct themes for use to create marketing campaigns using a proposed design created by the retail establishment. Some themes may be general in nature and are created for time of year or national holidays. Some themes are designed to target potential customers with specific demographic or psychographic profiles. These templates are created by professional designers and copywriters well-versed in consumer advertising. The design templates further include placeholders, which allow retail establishment 110 to specify what products or services are featured in the local store promotion. The IDCS includes libraries of product images and text elements that a retail establishment may browse through and select to include in the proposed design. The selected pictorial images and text elements are displayed in real time on the design template displayed in a work area on a computer to provide immediate feedback. Additionally, the IDCS accepts optional inputs from the retail establishment for use as headlines or sub-headlines in the marketing material to further customize the design.

The retail establishment then selects a coupon offer template if desired. Multiple coupon offer templates are available, depending on how many coupon offers the retail establishment intends to include in the marketing materials, whether the coupon offers include text only or both text and graphic elements, etc. The retail establishment specifies exact content for each coupon offer, including headline, sub-headline, price point and graphic element.

To complete the proposed design, the retail establishment specifies whether a trade name or logo, either proprietary or franchised, are to be included in the design of the marketing material. Text and graphic elements may be input by the retail establishment into the proposed design. The retail establishment also provides a location address. A map, an artistic rendition of the geographic location of the retail establishment, is created by a graphic artist employed by a printer and included in the final design on a medium suitable for print production. Retail establishment then specifies the delivery method and then submits a conditional purchase order, pending approval by all necessary parties.

The Project Management System (PMS) 400 keeps track of the orders and each corporate sponsor's approval requirements. When the retail establishment submits a conditional order, the PMS issues a job ticket identifying the order and all associated design elements. A graphic artist completes the proposed design using corresponding high-resolution images in a medium suitable for print production to generate a completed design. The graphic artist reviews and modifies the proposed design if deemed necessary to ensure professional quality. After job completion, a low-resolution version of the completed design is created which is suitable for online viewing for approval purposes. PMS 400 checks to see whether retail establishment is part of a branded/franchise network, and if so, whether the pictorial or text elements used in the marketing material are pre-approved or require corporate sponsor's approval. If corporate sponsor approval is required, electronic files of the low-resolution version of the completed design are sent to retail establishment 110 and all parties within/without corporate sponsor's organization that must approve the local store marketing material. Entities likely to have review/approval authority are management 140, legal department 150 and corporate sponsor's advertising agency 160. PMS 400 sends out e-mail notifications to and receives replies from retail establishment 110 and all approval authorities, and keeps track of order progress. Retail establishment 110 is also notified of changes in order status. Print Production Allocation System (PPAS) 500 analyzes information on historical demand, in-progress orders pending approval, forecast demand and projected growth of customer base, and then determines how many press-runs by week need to be reserved with printers. This process is repeated periodically to ensure adequate press-runs are reserved to meet demand. Frequency of process depends on the magnitude and variability of demand. PPAS 500 reserves press time with printers based on demand forecast.

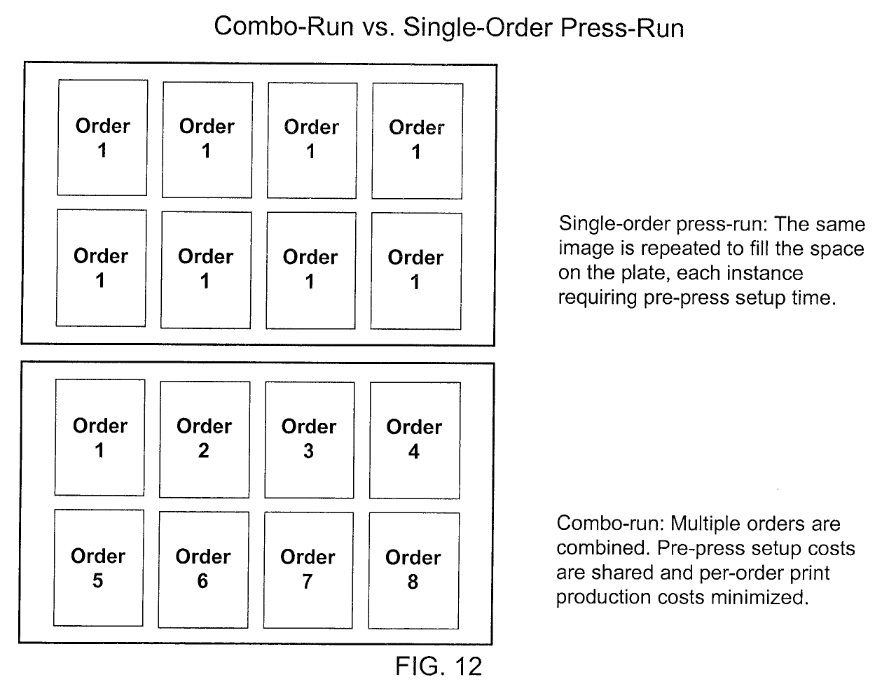

Print production costs vary greatly depending on the specifics of the print job. A significant portion of the print production costs is incurred to properly set up the job on the press (i.e., pre-press production costs). Images are transferred, from disk or film, to plate. Depending on the dimensions of the image, an exemplary single-order job entails the same image being repeated multiple times on the plate, with each instance requiring pre-press time and incurring costs. Therefore, substantial per-order print production cost savings may be achieved when multiple orders are combined in the same press-run. This is commonly known as a “combo-run” in the printing industry. A combo-run allows the sharing of pre-press production costs and press time, thereby minimizing per-order print production costs. A comparison of combo-run vs. single-order press-run is depicted in FIG. 12.

PPAS 500 accesses information on completed orders and reserved press-runs. Orders are accumulated, combined and then allocated to a reserved press-run, subject to maximum number of orders per press sheet allowable and order deadlines. Electronic files of the combined orders are sent to the printer, along with instructions for handling each order output. The Retail establishment is notified of order progress.

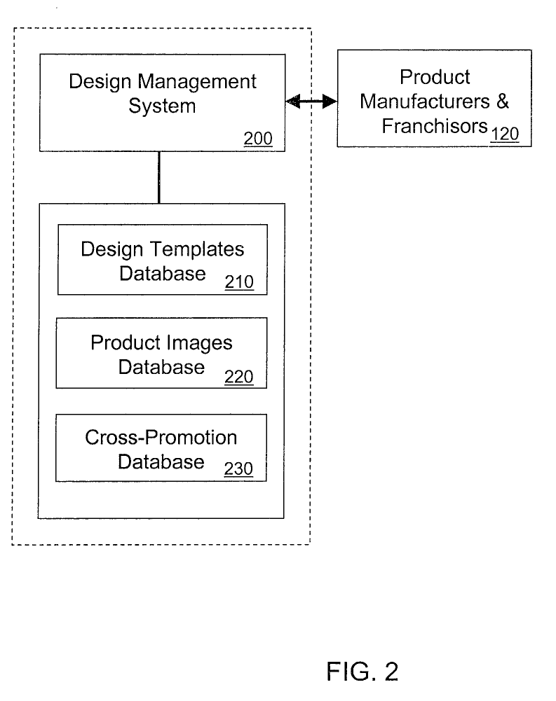

FIG. 2 depicts a block diagram of an exemplary DMS 200. The DMS allows franchisors to supply and keep current marketing material design templates, product images, graphic elements, promotional calendars and special promotional product offers. The DMS includes a variety of databases, including a design templates database 210, a product images database 220, and a cross-promotion database 230.

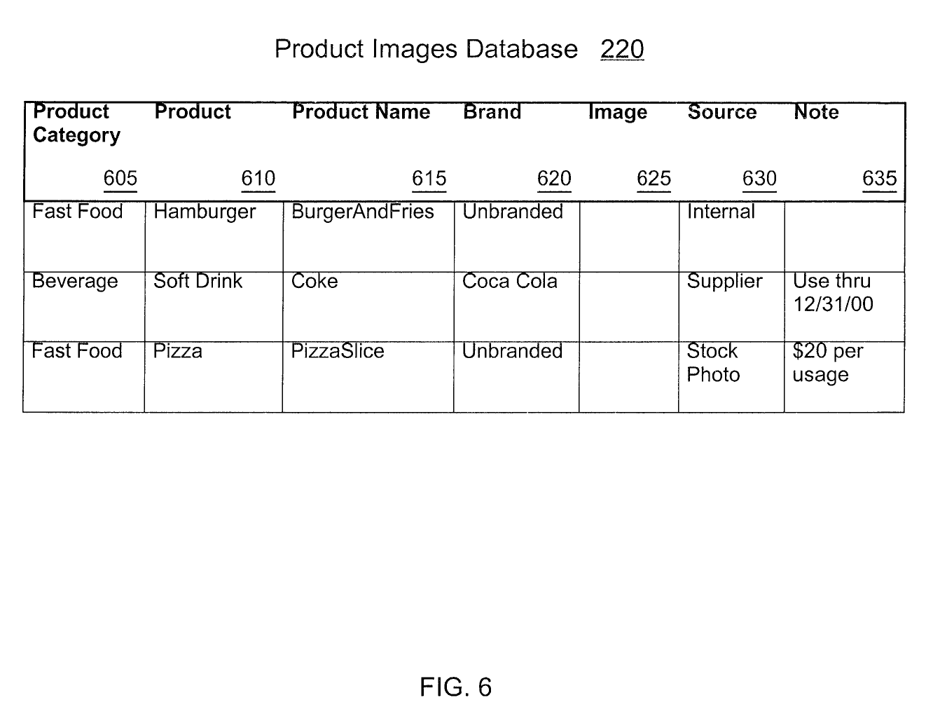

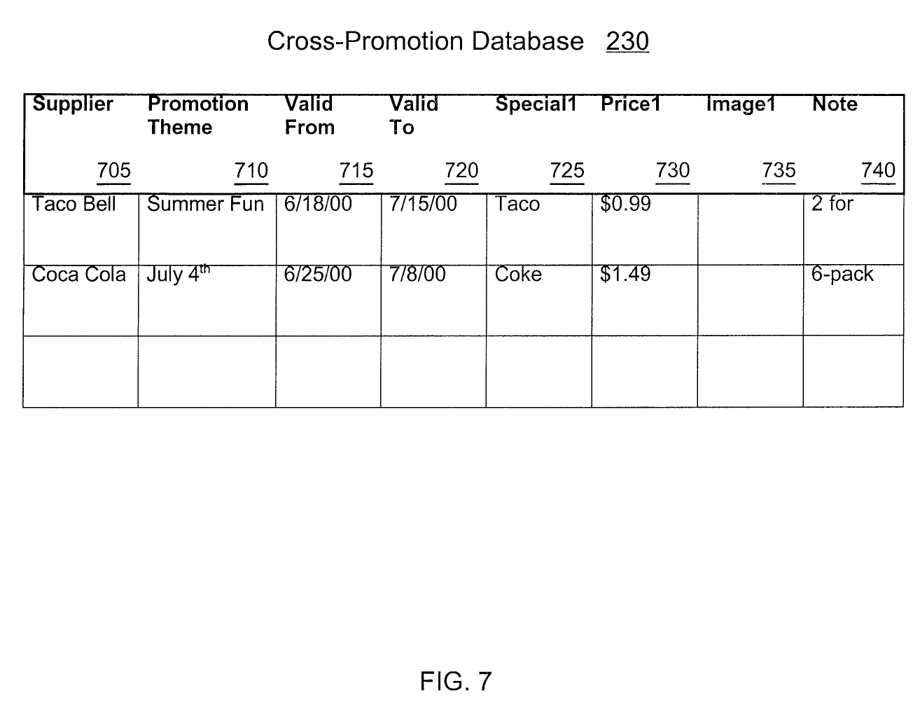

The design templates database includes pre-designed templates for creating local store marketing materials. The templates have different themes and include both graphic and text elements. The product images database includes graphic and photographic images of various products and services that may be featured in local store promotions. The cross-promotion database includes current promotions and specials offered by franchisors. The format and content of the databases depicted in FIG. 2 are discussed in detail hereinafter in conjunction with FIG. 6 and FIG. 7.

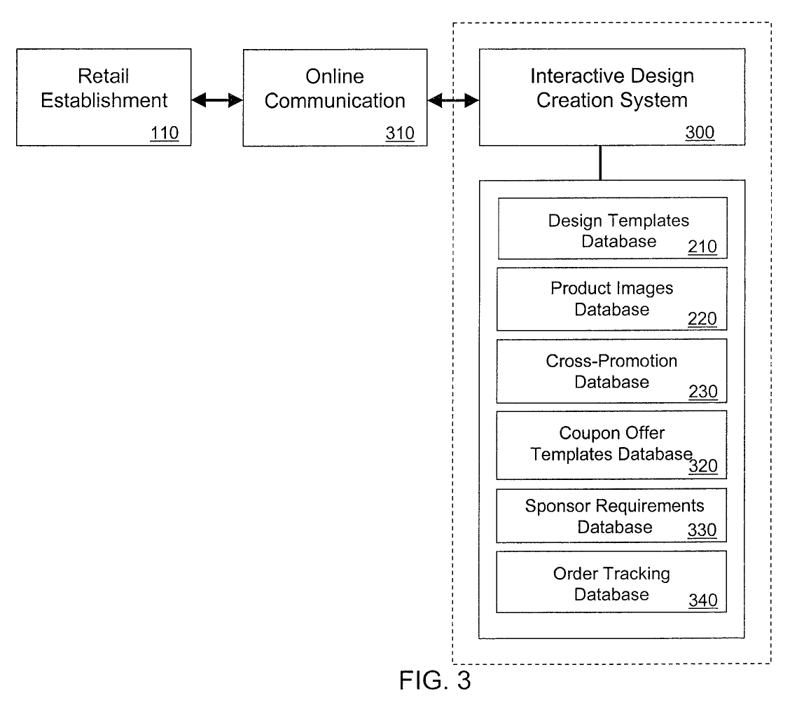

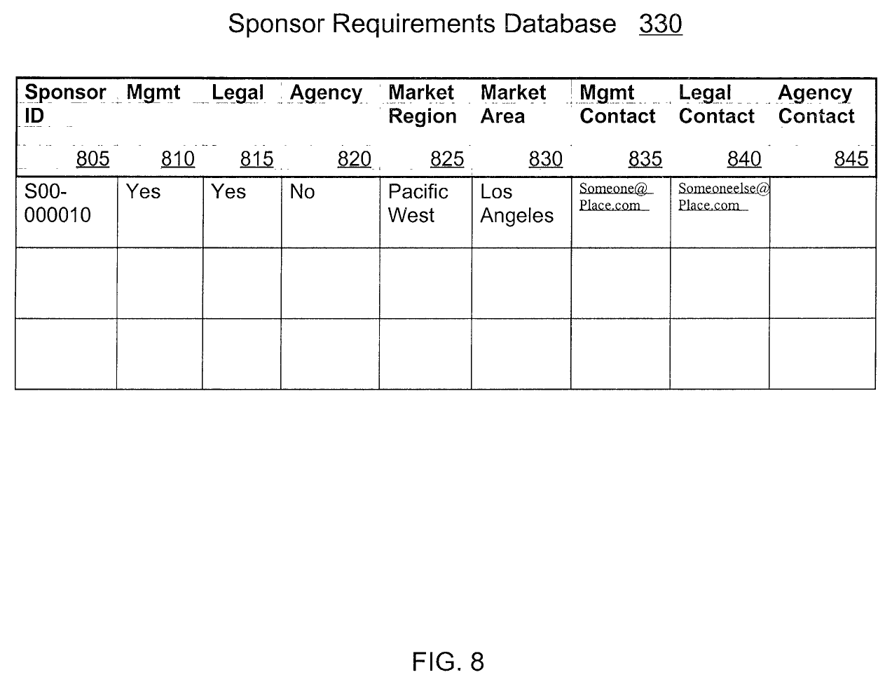

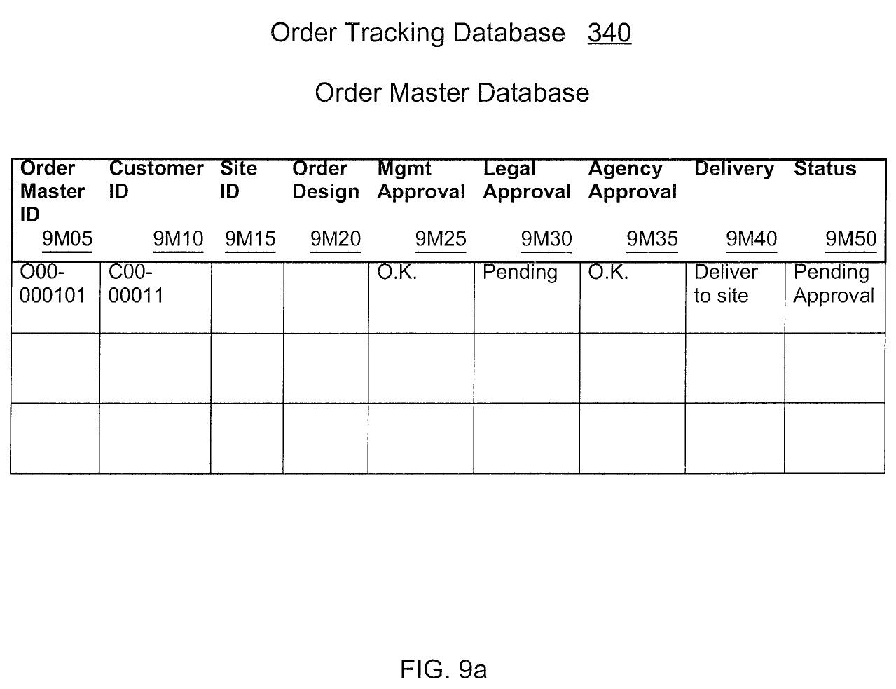

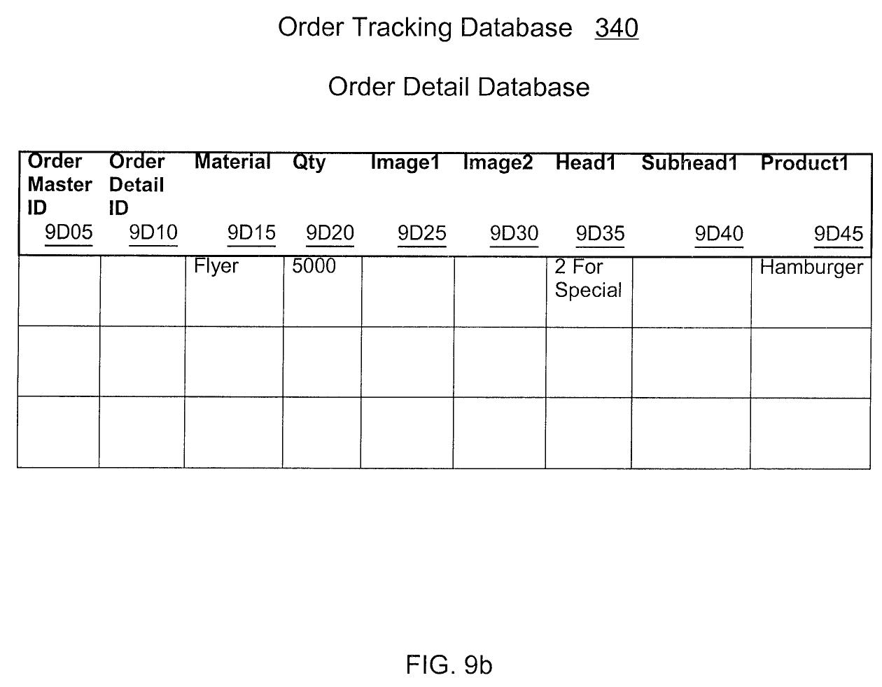

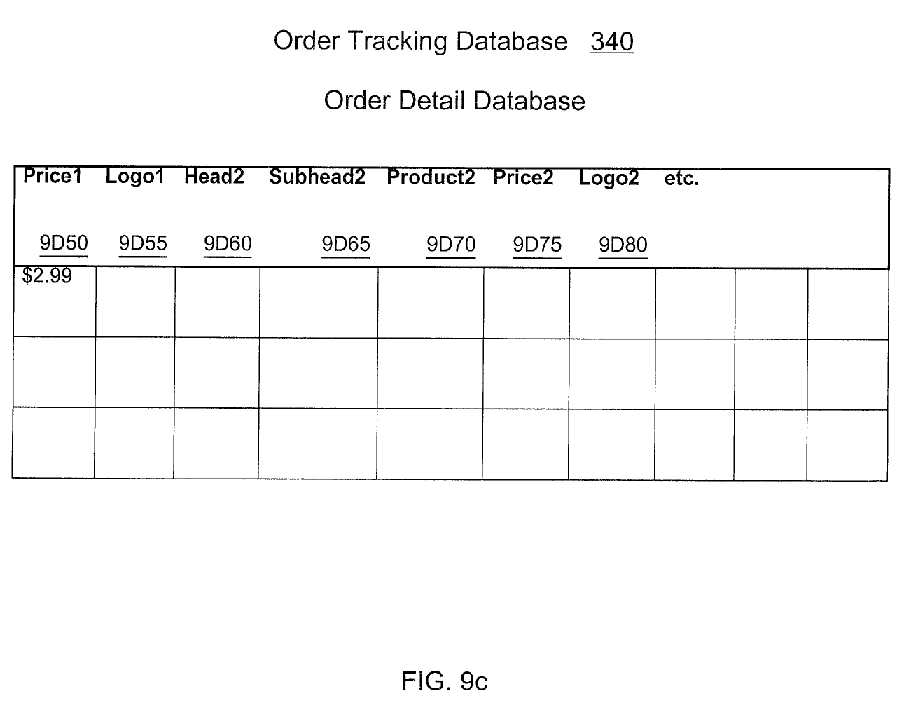

FIG. 3 depicts a block diagram of an exemplary IDCS 300. The IDCS is the interface module that a retail establishment 110 accesses online to create custom marketing materials. The retail establishment may log on and be guided step-by-step through easy-to-follow procedures to create a customized design and place an order. The IDCS includes a variety of databases, including a design templates database 210, a product images database 220, a cross-promotion database 230, a coupon offer templates database 320, a sponsor requirements database 330, and an order tracking database 340. The first three databases are the same as the like-identified databases in the previously described DMS. The sponsor requirements database 330 includes specific requirements and contact persons for each corporate sponsor that has established an alliance with the webLSM server. The order tracking database 340 includes detailed information about each order that allows for order tracking and is used in demand forecast analysis. The format and content of the databases depicted in FIG. 3 are discussed in detail hereinafter in conjunction with FIG. 8 and FIG. 9.

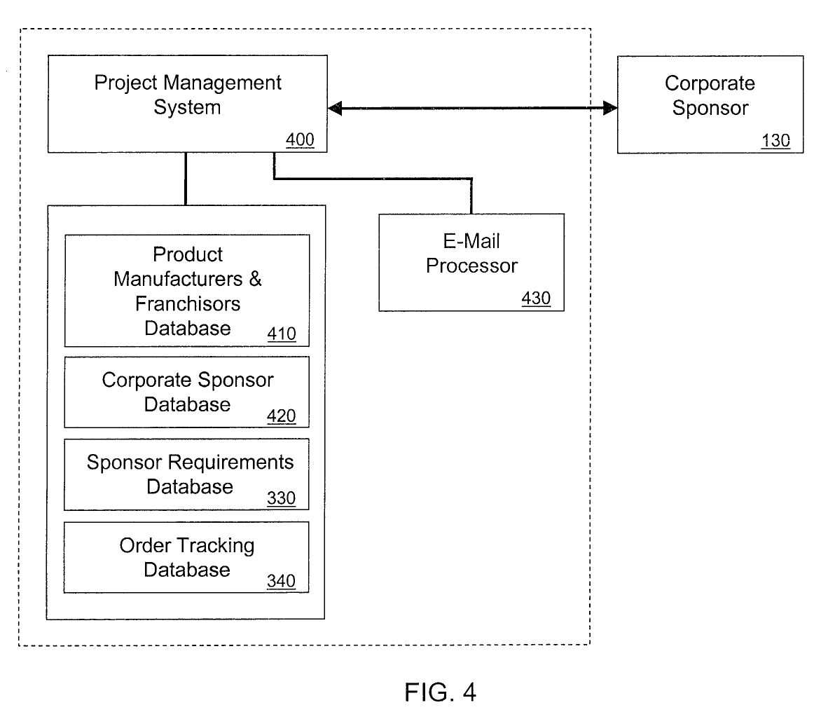

FIG. 4 depicts a block diagram of an exemplary PMS 400. The PMS 400 maintains and keeps up-to-date a variety of databases and tracks order progresses. The PMS 400 is also coupled to an electronic-mail processor 430 for processing and storing e-mail messages transmitted between PMS 400 and retail establishments, franchisors, and corporate sponsor. PMS 400 tracks order status through the approval and print allocation processes.

The PMS includes a variety of databases, including a franchisors Database 410, a corporate sponsors database 420, a sponsor requirements database 330, and an order tracking database 340. The latter two are the same as the like-identified databases in the IDCS 300.

The franchisors database includes information on manufacturers and franchisors offering branded or franchised products and services that have established relationships with webLSM. The relationships allow manufacturers and franchisors to disseminate information and provide pre-approved graphic elements to facilitate their usage in local store promotions. The corporate sponsors database 420 includes information on corporate entities that have established alliances with webLSM, including pertinent details in the contractual agreements such as pricing discounts.

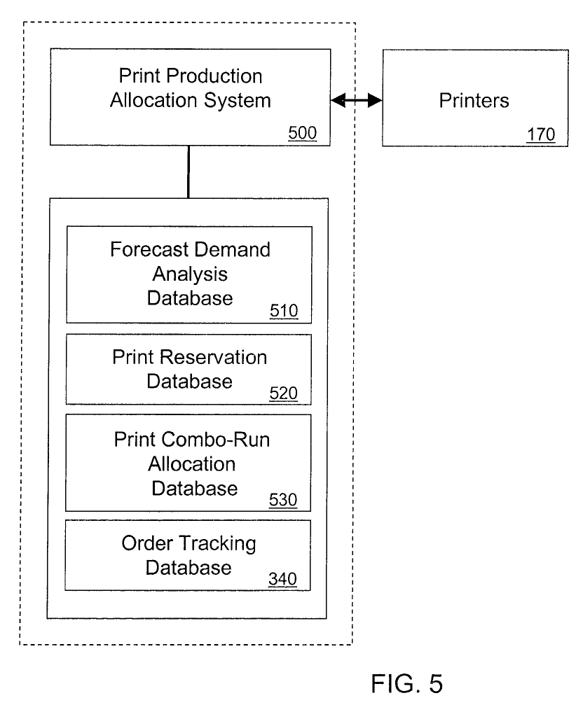

FIG. 5 depicts a block diagram of an exemplary PPAS 500. The PPAS 500 performs functions related to press time reservation and combined-order allocation, including forecasting demand and press-runs needed, reserving press time with printers, and combining and allocating orders to specific press-runs.

The PPAS includes a variety of databases, including a forecast demand analysis database 510, a print reservation database 520, a print combo-run allocation database 530, and an order tracking database 340. The order tracking database is the same as the like-identified database in the IDCS 300.

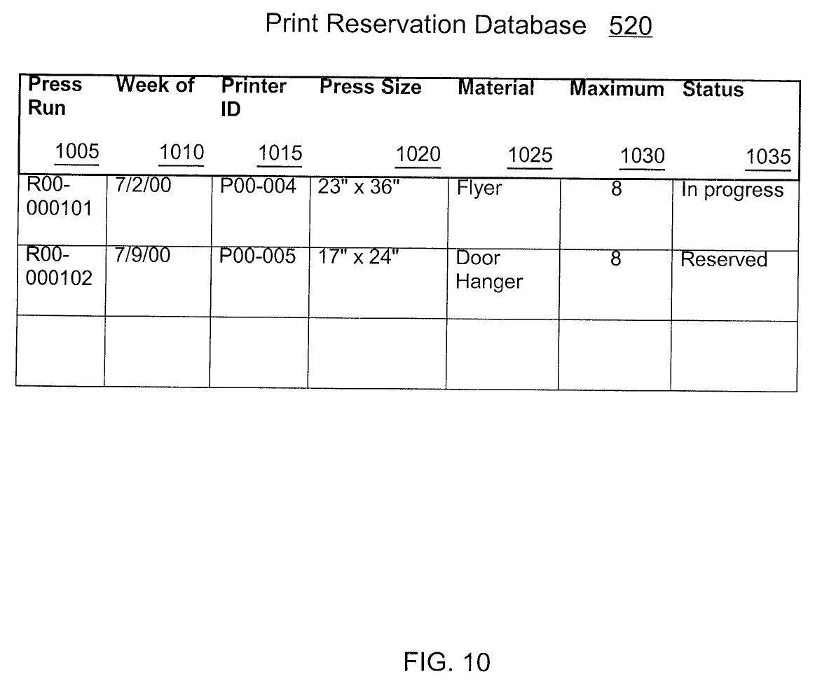

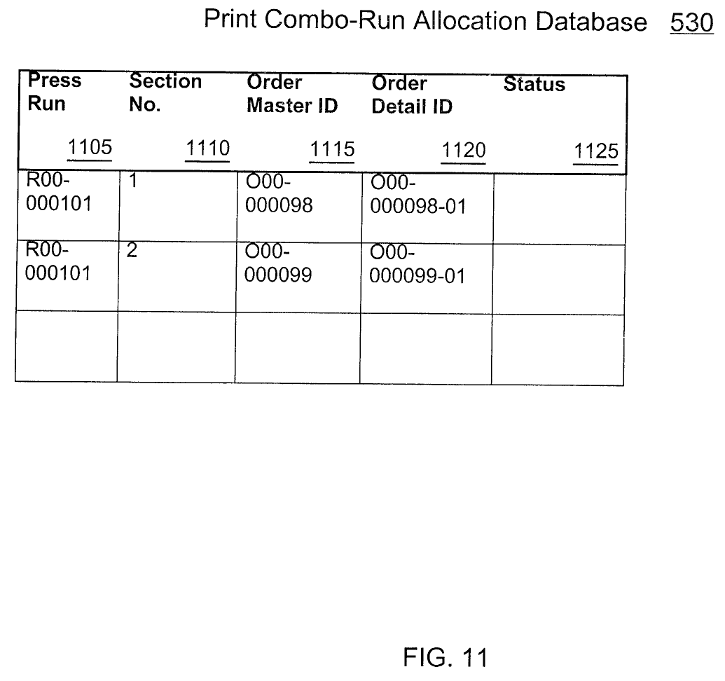

The forecast demand analysis database includes information on historical demand, in-progress order, forecast demand and projected growth of customer base. Press-run needs, by week, are forecast based on the above information. The print reservation database 520 includes information on press-time reservations with pre-screened printers. The print combo-run allocation database includes information on accumulated, combined orders and press-run allocations. The format and content of the databases depicted in FIG. 5 are discussed in detail hereinafter in conjunction with FIG. 10 and FIG. 11.

FIG. 6 illustrates an exemplary product images database 220 which includes graphic and photographic images of various products and services that may be featured in local store promotions. The product images database maintains a plurality of records, each associated with a different product image. For each image, the product images database includes the product category in field 605, the product type in field 610, the specific name of the product to differentiate it from the other products of the same type in field 615, whether the product is generic or branded (i.e., provided by a branded franchiser) in field 620, and whether the product image is proprietary or is a stock photo requiring payment of usage fee in fields 630 and 635.

FIG. 7 illustrates an exemplary cross-promotion database 230 which includes current promotions and specials offered by franchisors. The cross-promotion database includes a plurality of records, each associated with a different promotion. For each promotion, the cross-promotion database includes the supplier who offers the promotion in field 705, the promotional theme in field 710, the valid from/to dates in fields 715 and 720, and information on the specific product featured in the promotion in fields 725-740.

FIG. 8 illustrates an exemplary sponsor requirements database 330 which includes specific requirements and contact persons for each corporate sponsor. The sponsor requirements database maintains a plurality of records, each associated with a different marketing area of a corporate sponsor. For each marketing area of a corporate sponsor, the sponsor requirements database includes which entities have approval authority in fields 810-820, and contact information in fields 835-845.

FIG. 9 illustrates an exemplary order tracking database 340 which includes detailed information about each order that allows for order tracking. The order tracking database 340 is further broken down into two databases. The order master database, as depicted in FIG. 9a, includes header information for each order which identifies each order and allows for tracking through the approval process. Each record in the database is associated with a different order. The order detail database, as depicted in FIGS. 9b and 9c, includes detail information for each type of marketing material included in an order, the quantity of each type of marketing material ordered, and the content customization information including product image selections and coupon offers. Each record in the database is associated with a different type of marketing material ordered. For instance, if an order includes 3 different types of marketing materials (i.e., flyers, door hangers and bag stuffers), then there is one record in the order master database for this order and 3 records in the order detail database for this order, each for a different marketing material.

FIG. 10 illustrates an exemplary print reservation database 520 which includes information on press-time reservations with pre-screened printers. The print reservation database 520 includes a plurality of records, each associated with a different press-run reserved for print production. For each press-run reservation, the print reservation database 520 includes the scheduled press time in field 1010, the printer in field 1015, the press size in field 1020, the type of marketing materials to be printed in field 1025, the maximum number of orders of said type that can be combined into a combo-run in field 1030, and current status in field 1035.

FIG. 11 illustrates an exemplary print combo-run allocation database 530 which includes information on cumulated, combined orders and press-run allocations. The print combo-run allocation database 530 maintains a plurality of records, each associated with a different section of a press-run. For each section of a press-run, the order master and the order detail are identified in fields 1115 and 1120, and current status in field 1125.

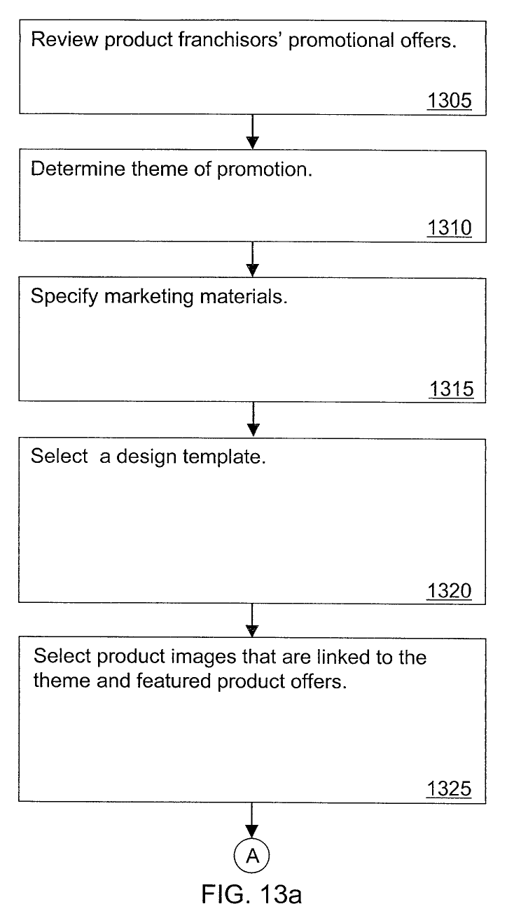

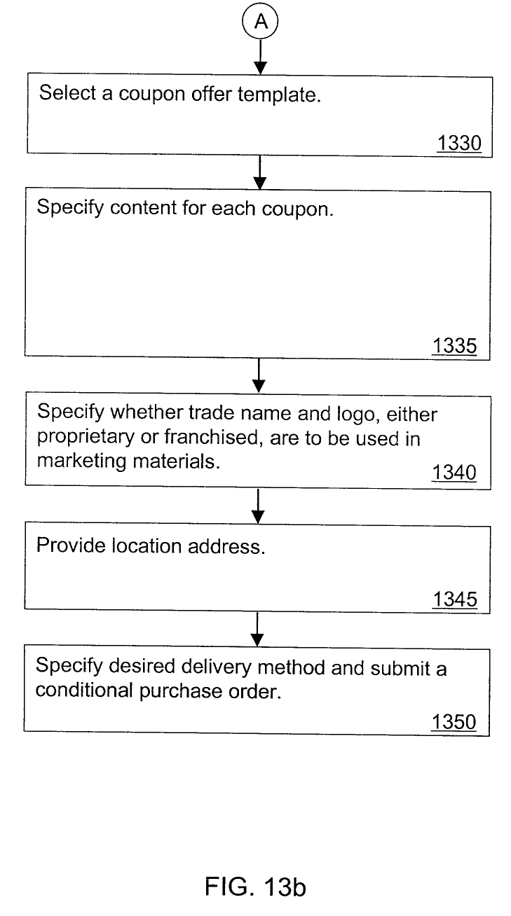

FIG. 13a and FIG. 13b illustrate the steps taken by a retail establishment in generating a proposed design using an embodiment of a webLSM server according to the present invention. Referring now to FIG. 13a, a retail establishment franchisors' promotional calendars, current promotions and special product offers at step 1305. At step 1310 the retail establishment determines a theme a promotion, cross-promotion opportunities, and products featured in the promotion. At step 1315, the retail establishment specifies marketing materials (e.g., building sign, flyer, door hanger, etc.) and quantities to be included in the order. All marketing materials are based on the same design specifications.

At step 1320, the retail establishment selects from a repertoire of pre-defined design templates. Each template includes a headline and a sub-headline, which may be customized, and placeholders for graphic images of products/services to be featured in the promotion. At step 1320 the retail establishment selects a design template from a plurality of pre-defined design templates. Each template includes a headline and a sub-headline, which are customizable by the retail establishment, and placeholders for graphic images of products/services to be featured in the promotion. At step 1325, the retial establishment reviews and selects product images that are linked to the theme and featured product offers. Graphic image selections and text element revisions are reflected in real time on the design template displayed in a work area on the retail establishment's host to provide immediate feedback the retail establishment.

Referring now to FIG. 13b, the retail establishment selects a coupon offer template, depending on desired number of coupon offers and style at step 1330. At step step 1335 the retail establishment specifies content for each coupon, including head, sub-head, price point, product offer and product brand logo. Customization is reflected in real time on the design template displayed in a work area on the retail establishment's host to provide immediate feedback. At step step 1340 the retail establishment specifies whether trade name and logo, either proprietary to the retail establishment or franchised, are to be used in marketing materials. At step step 1345 the retail establishment provides a location address. A map of the location address is included in the marketing materials. At step 1350 the retail establishment specifies desired delivery method and submits a conditional purchase order.

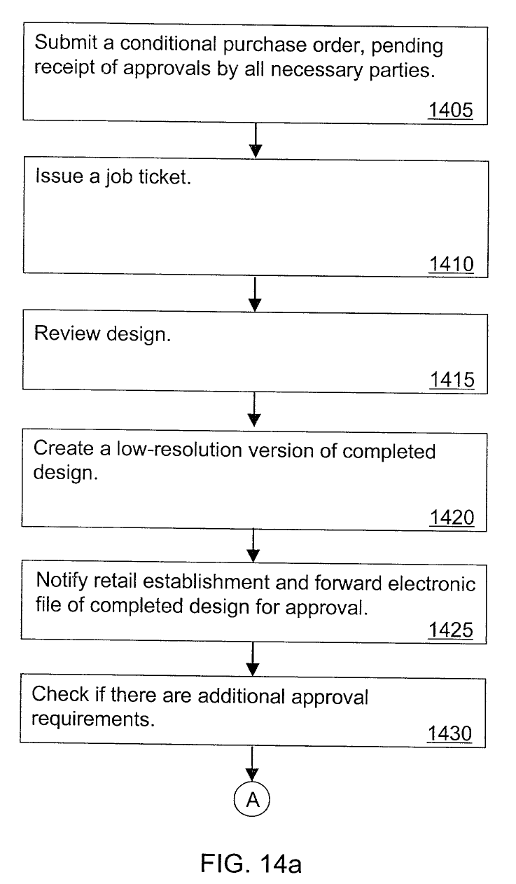

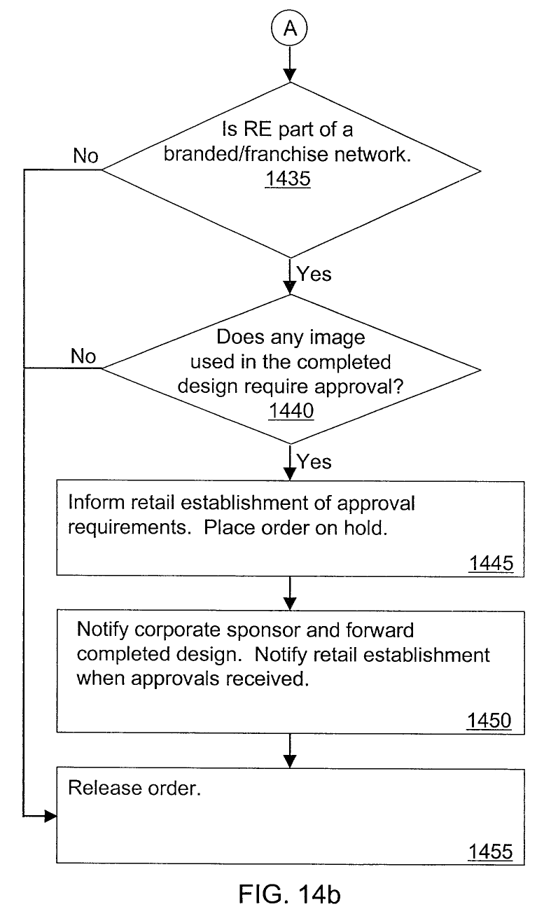

FIG. 14a and FIG. 14b illustrate the process of obtaining approvials for a proposed design according to an embodiment of the present invention. Referring now t FIG. 141, at step 1405, the retail establishment submits a conditional purchase order. The conditional purchase is pending until receipt of approvals by all necessary parties of a completed design. At step 1410, a previously described PMS issues a job ticket identifying the conditional purchase order and the conditional purchase order's associated design elements for a graphic artist to generate a completed design in a medium suitable for print production. At step 1415, a graphic artist reviews and modifies the proposed design if deemed necessary by the graphic artist to ensure the quality of the completed design. At step 1420, the PMS creates a low-resolution version of a completed design suitable for online viewing for approval purposes after the completed design is generated from the proposed design. At step 1425, the PMS notifies retail establishment that a completed deisgn was generated and forwards an electronic file of the completed design for approval from any necessary parties. At step 1430, the PMS checks to see whether there are additional approval requirements.

FIG. 14b is a process flow diagram depicting the steps in obtaining additional approvals according to an embodiment of the present invention. At step 1435, the webLSM server determines if the retail establishment is part of a branded/franchise network? If the retail establisment is not part of a branded/franchise network, then the PMS releases the conditional purchase order and the completed design is ready to be assigned to a press run at step 1455. If the retail establisment is part of a branded/franchise network, the PMS determines if an image included in the completed design requires approval. If no image included in the completed design requires approval, then the webLSM server releases the conditional purchase order and the completed design is ready to be assigned to a press run at step 1455. If an image included in the completed design requires approval, then the PMS informs the retail establishment of the approval requirement. The conditional purchase order is placed on hold pending corporate sponsor or franchisor approval at step 1445. At step 1450, the PMS notifies the corporate sponsor and forwards the completed design to the corporate sponsor for approval. When the PMS receives final approval of the completed design, the retail establishment is notified of the change in the conditional purchase order status. The PMS releases the conditional purchase order and the completed design is ready to be assigned to a press run at step 1455.

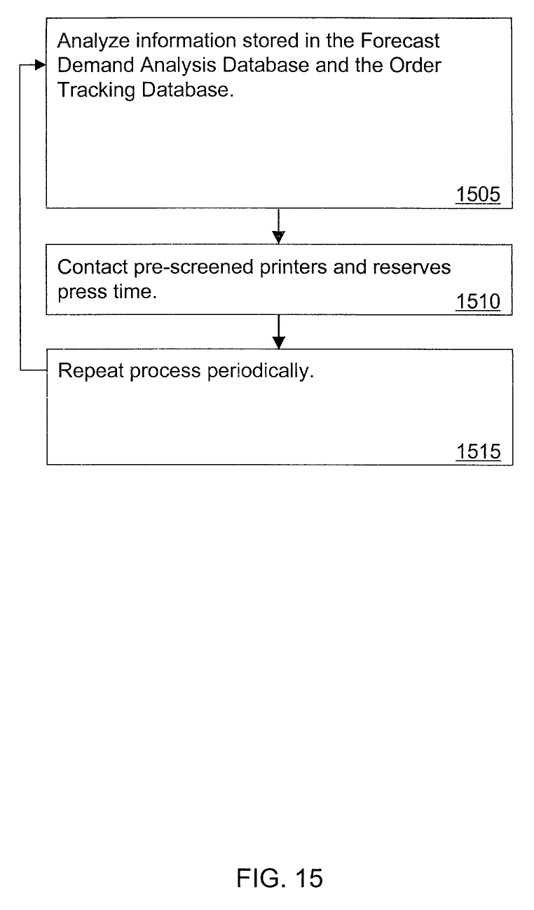

FIG. 15 is a process used by an embodiment of a PPAS module to reserve press runs according to the present invention. A previously described PPAS analyzes information stored in the forecast demand analysis database and the order tracking database, including historical demand, in-progress orders pending approval and forecast demand, and determines how many press-runs by week need to be reserved with printers at step 1505. The PPAS contacts pre-approved printers and reserves the required pressruns at step 1510. The PPAS repeats the press-run analysis, at step 1515, and press-run reservation periodically to ensure adequate press-runs are reserved to meet demand. The frequency of the repetition of the process depends on the magnitude and variability of demand.

The transmission of a press-run reservation may be transmitted to a printer using a variety of communication mediums with the selection of the appropriate communication medium dependent on the capabilities of the printer. In one embodiment of a webLSM server according to the present invention, a reservation may be transmitted to a printer via e-mail, telephone, or facsimile transmission.

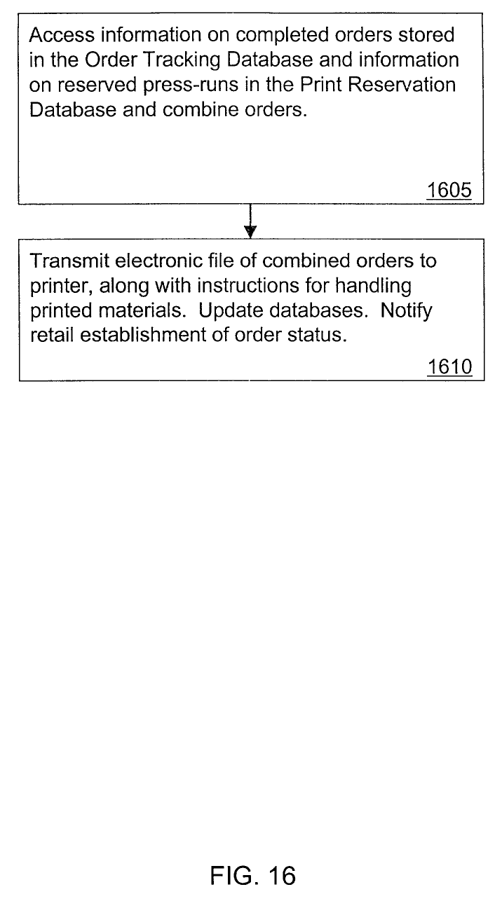

FIG. 16 is a process flow diagram depicting the steps of an press-run accumulation and combination process of an embodiment of an exemplary PPAS module according to the present invention. At step 1605, the PPAS accesses information on completed orders stored in a previously described order tracking database and information on reserved press-runs in the print reservation database. Orders are combined to reduce print production costs, subject to an allowable maximum number of orders per press sheet and printing deadlines. At step 1610, the PPAS transmits an electronic file of combined orders to a printer, along with instructions for handling any generated printed materials. The PPAS updates the print reservation database and order tracking database. The retail establishment is then notified of the order status.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by claims supported by this application and the claim's equivalents.

What is claimed is:

1. A computer implemented method for producing marketing materials for a retail establishment, comprising:
receiving marketing material information from a corporate sponsor;
generating a marketing material completed design using the corporate sponsor marketing material information;
transmitting the marketing material completed design to the corporate sponsor for approval; and
transmitting the marketing material completed design to a printer for production of the marketing materials upon receiving corporate sponsor approval.

2. The method of claim 1, wherein the corporate sponsor marketing material further includes:
pre-approved promotional calendars;
special product offers;
design templates;
product images;
graphic elements; and
logos.

3. The method of claim 1, wherein generating a marketing material completed design using the corporate sponsor marketing material information further includes:
presenting to the retail establishment the marketing material information; and
receiving from the retail establishment selected marketing material information, the selected marketing material information to be used to generate the marketing material completed design.

4. The method of claim 3, wherein receiving from the retail establishment selected marketing material information further includes transmitting a marketing material design template to the retail establishment, the marketing material design template to assist the retail establishment in selecting marketing material information.

5. The method of claim 4, wherein the marketing material design template further includes positional information for specifying the location of graphic images and text within the marketing material completed design.

6. The method of claim 4, wherein the marketing material design template further includes a coupon design template.

7. The method of claim 6, wherein the coupon design template includes positional information for specifying the location of graphic images and text within a coupon.

8. The method of claim 1 wherein generating a marketing material completed design using the corporate sponsor marketing material information further includes:
receiving a marketing material proposed design from the retail establishment;
transmitting the marketing material proposed design to a graphics designer; and
receiving from the graphics designer a marketing material completed design generated from the marketing material proposed design.

9. The method of claim 8 further including:
generating a low-resolution marketing material completed design from the marketing material completed design; and
transmitting the low-resolution marketing material completed design to the retail establishment for approval purposes.

10. The method of claim 1 wherein the marketing material completed design is used to produce a plurality of types of marketing materials.

11. The method of claim 1, further comprising:
receiving marketing material information from a franchiser; and
generating the marketing material completed design using the franchisor and corporate sponsor marketing material information.

12. The method of claim 11, further comprising submitting the marketing material completed design to the franchisor for approval.

13. The method of claim 1, wherein submitting the marketing material completed design to the corporate sponsor for approval further includes:
generation of a low-resolution marketing material completed design; and
transmission of the low-resolution marketing material completed design to the corporate sponsor via email for approval.

14. The method of claim 1, wherein transmitting the marketing material completed design to the corporate sponsor for approval further includes:
determining from the marketing material information approval requirements for the marketing material completed design;
generating a low-resolution marketing material completed design from the marketing material completed design; and
transmitting the low-resolution marketing material completed design via email to the corporate sponsor.

15. The method of claim 1, wherein transmitting the marketing material completed design to a printer for production of the marketing materials upon receiving corporate sponsor approval further includes:
analyzing historical demand, in-progress orders pending approval, and forecast demand to determine press-run needs; and
reserving press time with the printer to meet the press-run needs.

16. The method of claim 15, wherein reserving press time with the printer to meet the press-run needs further includes transmitting a reservation to a printer via a communication medium selected from the group consisting of e-mail, telephone, and facsimile transmission.

17. The method of claim 1, wherein transmitting the marketing material completed design to a printer for production of the marketing materials upon receiving corporate sponsor approval further includes:
accumulating a plurality of marketing material completed designs;
generating a combined press run from the plurality of marketing material completed designs; and
transmitting the combined press run to a printer for production of the marketing materials.

18. A data processing system adapted to produce marketing materials for a retail establishment via a computer network, comprising:
a processor; and
a memory operably coupled to the processor and having program instructions stored therein, the processor being operable to execute the program instructions, the program instructions including:
receiving marketing material information from a corporate sponsor;
generating a marketing material completed design using the corporate sponsor marketing material information;
transmitting the marketing material completed design to the corporate sponsor for approval; and
transmitting the marketing material completed design to a printer for production of the marketing materials upon receiving corporate sponsor approval.

19. The data processing system of claim 18, wherein the corporate sponsor marketing material further includes:
pre-approved promotional calendars;
special product offers;
design templates;
product images;
graphic elements; and
logos.

20. The data processing system of claim 18, wherein the program instructions for generating a marketing material completed design using the corporate sponsor marketing material information further include:
presenting to the retail establishment the marketing material information; and
receiving from the retail establishment selected marketing material information, the selected marketing material information to be used to generate the marketing material completed design.

21. The data processing system of claim 20, wherein the program instructions for receiving from the retail establishment selected marketing material information further include transmitting a marketing material design template to the retail establishment, the marketing material design template to assist the retail establishment in selecting marketing material information.

22. The data processing system of claim 21, wherein the marketing material design template further includes positional information for specifying the location of graphic images and text within the marketing material completed design.

23. The data processing system of claim 21, wherein the marketing material design template further includes a coupon design template.

24. The data processing system of claim 23, wherein the coupon design template includes positional information for specifying the location of graphic images and text within a coupon.

25. The data processing system of claim 18, wherein the program instructions for generating a marketing material completed design using the corporate sponsor marketing material information further include:
receiving a marketing material proposed design from the retail establishment;
transmitting the marketing material proposed design to a graphics designer; and
receiving from the graphics designer a marketing material completed design generated from the marketing material proposed design.

26. The data processing system of claim 25, wherein the program instructions further include:
generating a low-resolution marketing material completed design from the marketing material completed design; and
transmitting the low-resolution marketing material completed design to the retail establishment for approval purposes.

27. The data processing system of claim 18 wherein the marketing material completed design is used to produce a plurality of types of marketing materials.

28. The data processing system of claim 18, wherein the program instructions further include:
receiving marketing material information from a franchiser; and
generating the marketing material completed design using the franchiser and corporate sponsor marketing material information.

29. The data processing system of claim 28, wherein the program instructions further include submitting the marketing material completed design to the franchiser for approval.

30. The data processing system of claim 18, wherein the program instructions for submitting the marketing material completed design to the corporate sponsor for approval further include:
generation of a low-resolution marketing material completed design; and
transmission of the low-resolution marketing material completed design to the corporate sponsor via email for approval.

31. The data processing system of claim 18, wherein the program instructions for transmitting the marketing material completed design to the corporate sponsor for approval further include:
determining from the marketing material information approval requirements for the marketing material completed design;
generating a low-resolution marketing material completed design from the marketing material completed design; and
transmitting the low-resolution marketing material completed design via email to the corporate sponsor.

32. The data processing system of claim 18, wherein the program instructions for transmitting the marketing material completed design to a printer for production of the marketing materials upon receiving corporate sponsor approval further include:
analyzing historical demand, in-progress orders pending approval, and forecast demand to determine press-run needs; and
reserving press time with the printer to meet the press-run needs.

33. The data processing system of claim 32, wherein the program instructions for reserving press time with the printer to meet the press-run needs further include transmitting a reservation to a printer via a communication medium selected from the group consisting of e-mail, telephone, and facsimile transmission.

34. The data processing system of claim 18, wherein the program instructions for transmitting the marketing material completed design to a printer for production of the marketing materials upon receiving corporate sponsor approval further include:
accumulating a plurality of marketing material completed designs;
generating a combined press run from the plurality of marketing material completed designs; and
transmitting the combined press run to a printer for production of the marketing materials.

35. A computer readable media embodying computer program instructions for execution by a computer, the computer program instructions adapting a computer to produce marketing materials for a retail establishment via a computer network, computer program instructions comprising:
receiving marketing material information from a corporate sponsor;
generating a marketing material completed design using the corporate sponsor marketing material information; transmitting the marketing material completed design to the corporate sponsor for approval; and
transmitting the marketing material completed design to a printer for production of the marketing materials upon receiving corporate sponsor approval.

36. The computer readable media of claim 35, wherein the corporate sponsor marketing material further includes:
pre-approved promotional calendars;
special product offers;
design templates;
product images;
graphic elements; and
logos.

37. The computer readable media of claim 35, wherein the computer program instructions for generating a marketing material completed design using the corporate sponsor marketing material information further include:
presenting to the retail establishment the marketing material information; and
receiving from the retail establishment selected marketing material information, the selected marketing material information to be used to generate the marketing material completed design.

38. The computer readable media of claim 37, wherein the computer program instructions for receiving from the retail establishment selected marketing material information further include transmitting a marketing material design template to the retail establishment, the marketing material design template to assist the retail establishment in selecting marketing material information.

39. The computer readable media of claim 38, wherein the marketing material design template further includes positional information for specifying the location of graphic images and text within the marketing material completed design.

40. The computer readable media of claim 38, wherein the marketing material design template further includes a coupon design template.

41. The computer readable media of claim 40, wherein the coupon design template includes positional information for specifying the location of graphic images and text within a coupon.

42. The computer readable media of claim 35, wherein the computer program instructions for generating a marketing material completed design using the corporate sponsor marketing material information further include:
receiving a marketing material proposed design from the retail establishment;
transmitting the marketing material proposed design to a graphics designer; and
receiving from the graphics designer a marketing material completed design generated from the marketing material proposed design.

43. The computer readable media of claim 42, wherein the computer program instructions further comprise:
generating a low-resolution marketing material completed design from the marketing material completed design; and
transmitting the low-resolution marketing material completed design to the retail establishment for approval purposes.

44. The computer readable media of claim 35, wherein the marketing material completed design is used to produce a plurality of types of marketing materials.

45. The computer readable media of claim 35, wherein the computer program instructions further comprise:
receiving marketing material information from a franchiser; and
generating the marketing material completed design using the franchiser and corporate sponsor marketing material information.

46. The computer readable media of claim 45, wherein the computer program instructions further comprise submitting the marketing material completed design to the franchiser for approval.

47. The computer readable media of claim 35, wherein the computer program instructions for submitting the marketing material completed design to the corporate sponsor for approval further include:
generation of a low-resolution marketing material completed design; and
transmission of the low-resolution marketing material completed design to the corporate sponsor via email for approval.

48. The computer readable media of claim 35, wherein the computer program instructions for transmitting the marketing material completed design to the corporate sponsor for approval further include:
determining from the marketing material information approval requirements for the marketing material completed design;
generating a low-resolution marketing material completed design from the marketing material completed design; and
transmitting the low-resolution marketing material completed design via email to the corporate sponsor.

49. The computer readable media of claim 35, wherein the computer program instructions for transmitting the marketing material completed design to a printer for production of the marketing materials upon receiving corporate sponsor approval further include:
analyzing historical demand, in-progress orders pending approval, and forecast demand to determine press-run needs; and
reserving press time with the printer to meet the press-run needs.

50. The computer readable media of claim 49, wherein the computer program instructions for reserving press time with the printer to meet the press-run needs further include transmitting a reservation to a printer via a communication medium selected from the group consisting of e-mail, telephone, and facsimile transmission.

51. The computer readable media of claim 35, wherein the computer program instructions for transmitting the marketing material completed design to a printer for production of the marketing materials upon receiving corporate sponsor approval further include:
accumulating a plurality of marketing material completed designs;
generating a combined press run from the plurality of marketing material completed designs; and
transmitting the combined press run to a printer for production of the marketing materials.
